(19) United States
(12) Patent Application Publication
(10) Pub. No.: US 2026/0116103 A1
(43) Pub. Date: Apr. 30, 2026

(54) BAG PRINTER AND DISPENSER AND PACKAGING SYSTEM WITH SUCH A BAG PRINTER AND DISPENSER

(71) Applicant: ID Technology LLC, Ft. Worth, TX (US)

(72) Inventor: Thomas L. GLATFELTER, York, PA (US)

(21) Appl. No.: 19/003,559

(22) Filed: Dec. 27, 2024

Related U.S. Application Data
(60) Provisional application No. 63/617,114, filed on Jan. 3, 2024.

(51) Int. Cl. B41J 15/04; B41J 3/407; B41J 11/00; B41J 25/00; B41J 29/02; B41J 29/56; B41M 5/00; B65B 61/02

(52) U.S. Cl. CPC B41J 15/042; B41J 3/407; B41J 11/0095; B41J 25/001; B41J 29/02; B41J 29/56; B41M 5/0047; B41M 5/0064; B65B 61/025

(57) ABSTRACT

A bag printer and dispenser apparatus includes a holding structure for a bag supply web formed by a plurality of shingled bags, and a print and dispense mechanism engaged on the holding structure. The print and dispense mechanism includes a feed path along which the bag supply web is routed, and a thermal inkjet printer positioned adjacent the feed path and mounted for movement along a web traversing path that runs across at least part of a width of the bag supply web for printing on bags.

### TECHNICAL FIELD

The present application relates generally to packaging items in bags and, more particularly, to a bag printer and dispenser used in connection with packaging items in bags.

### BACKGROUND

Foods products, such as meat, cheese and the like, are conventionally packaged in plastic bags. U.S. Pat. No. 6,837,023 discloses a printer for shingled bags used for packaging items in an automated bagger system. In some packaging environments, bags are manually separated from a shingled web of bags for use.

It would be desirable to provide a bag dispenser and associated printer suited for use in connection with such manual bag separation environments.

### SUMMARY

In one aspect, a bag printer and dispenser apparatus includes a holding structure for a bag supply web formed by a plurality of shingled bags; and a print and dispense mechanism engaged on the holding structure, the print and dispense mechanism including a feed path along which the bag supply web is routed, and a thermal inkjet printer positioned adjacent the feed path and mounted for movement along a web traversing path that runs across at least part of a width of the bag supply web for printing on bags.

In another aspect, a bag printer and dispenser apparatus includes a holding structure for a bag supply web formed by a plurality of shingled bags, and a print and dispense mechanism engaged on the holding structure. The print and dispense mechanism includes: a feed path along which the bag supply web is routed; an inkjet printer positioned adjacent the feed path and mounted for movement along a web traversing path that runs across at least part of a width of the bag supply web for printing on bags; a bag web feeder for selectively feeding the bag supply web along the feed path; and a control system configured for detecting a leading end of a leading bag of the bag supply web when the leading bag reaches a retrieval location, the control system configured to control operation of the bag web feeder such that the leading bag is held in the retrieval location until the leading bag is separated from the bag supply web, wherein the web traversing path overlies a portion of a face of the leading bag when the leading bag is in the retrieval location, and a leading section of the bag runs in a downward direction when the leading bag is in the retrieval location.

In a further aspect, a method of printing and dispensing bags from a bag supply web formed by a plurality of shingled bags is provided, the method involving: selectively feeding the bag supply web along a feed path past a print location; operating a thermal inkjet printer to traverse across at least part of a width of the bag supply web while printing on a face of a leading bag of the bag supply web; holding the leading bag of the bag supply web in a retrieval location in which a leading section of the leading bag extends in a downward direction and the face of the leading bag is still aligned with a traversal path of the thermal inkjet printer.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a packaging environment in top plan view;

FIG. 2 shows an exemplary bag supply web;

FIGS. 3 and 4 show perspective views of a bag printer and dispenser;

FIG. 5 shows a partial perspective of the bag printer and dispenser;

FIGS. 6 and 7 show top plan and side elevation views of the bag printer and

dispenser;

FIGS. 8 and 9 show partial perspectives of a bag dispense end of the bag printer and dispenser;

FIG. 10 shows portions of a lower region of the bag dispense end with bag supply web shown;

FIG. 11 shows portions of a lower region of the bag dispense end with bag supply web not shown;

FIG. 12 shows a partial cross-section of the bag dispense end;

FIG. 13 shows another partial cross-section of the bag dispense end;

FIG. 14 shows a perspective view of the bag printer and dispenser without the bag supply box;

FIG. 15 shows a perspective view the bag printer and dispenser without the bag supply box or bag supply web;

FIG. 16 shows a partial perspective with certain portions hidden; and

FIG. 17 shows a partial perspective of a mount arrangement of the printer to the carriage.

### DETAILED DESCRIPTION

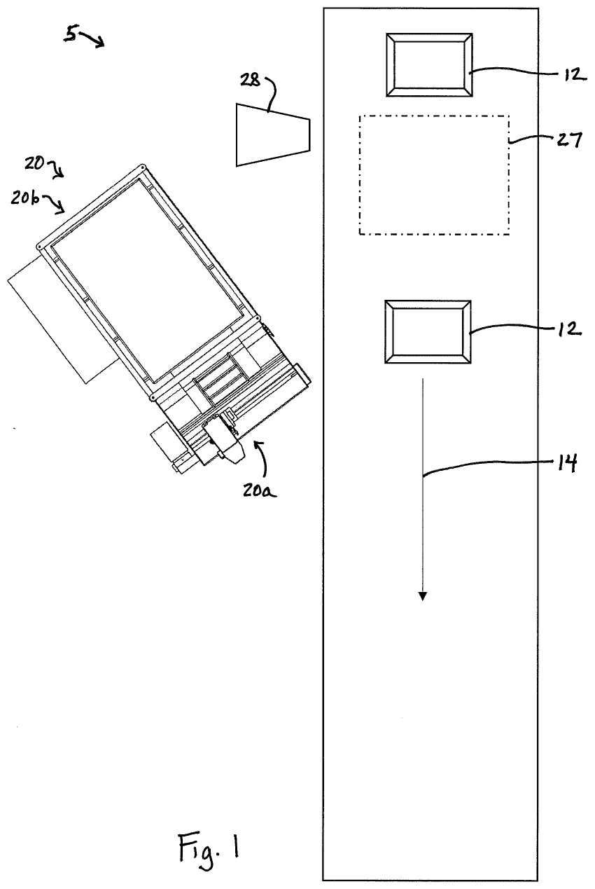

Referring to FIG. 1, an exemplary packaging system or environment 5 is shown in which a conveyor 10 carries items 12 to be packaged along the path of conveyance in a conveyance direction 14. A bag printer and dispenser 20 is provided alongside the conveyance path to enable a person to manually retrieve a bag from a dispense end 20a and then place the item 12 in the bag. The bagged item may then be placed back on the conveyor for movement to a downstream station at which, for example, the bag is vacuum sealed.

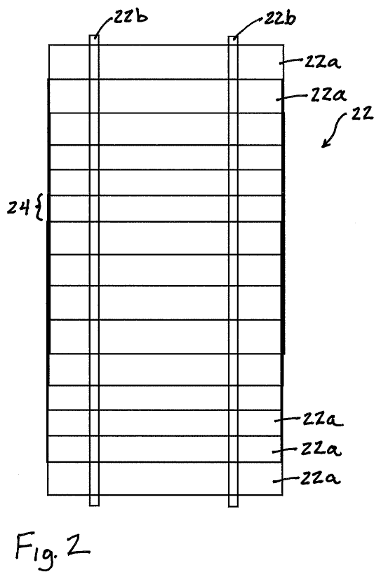

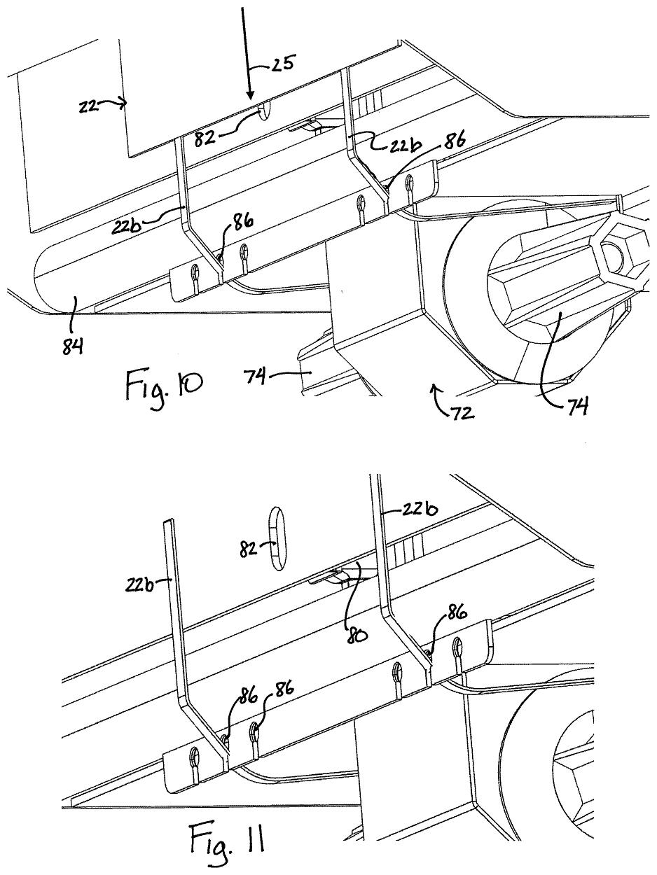

Referring to FIG. 2, an exemplary supply of bags in the form of a bag supply web 22 that includes multiple bags 22a overlapped in a shingled manner and connected to one or more adhesive strips or tapes 22b (e.g., ¼″ to ½″ wide) such that the bags are held together in a shingled web form, with the bags 22a being individually separable by pulling away from or off of the adhesive strips 22b. Each bag 22a may have a closed/sealed end (e.g., a leading end of the bag relative to the feed direction 25 (FIG. 10) of the bag along the bag feed path) and an open end (e.g., a trailing end of the bag relative to the feed direction). A shingle spacing 24 between the bags may vary depending on the bag supply, with spacings 24 on the order of ½″ to 1″ being be typical, though other spacings are possible. The shingle spacing also defines the lengthwise portion of each bag that is adhesively held to the strips or tapes 22b. Each bag 22a may be blank (e.g., entirely clear or entirely of a consistent shade or color) or may be pre-printed with some information, such as logos, branding etc.

The bag printer and dispenser 20 is provided to print additional information on each bag, such as date (e.g., date and time of packing) and source (e.g., identifier of packing location). Additional information that is printed could also be more item dependent, such as weight of the item as indicated by a weighing station 27 along the conveyance path and/or item dimensions or identity as determined by an item sensor 28 (e.g., a scanner or a camera system).

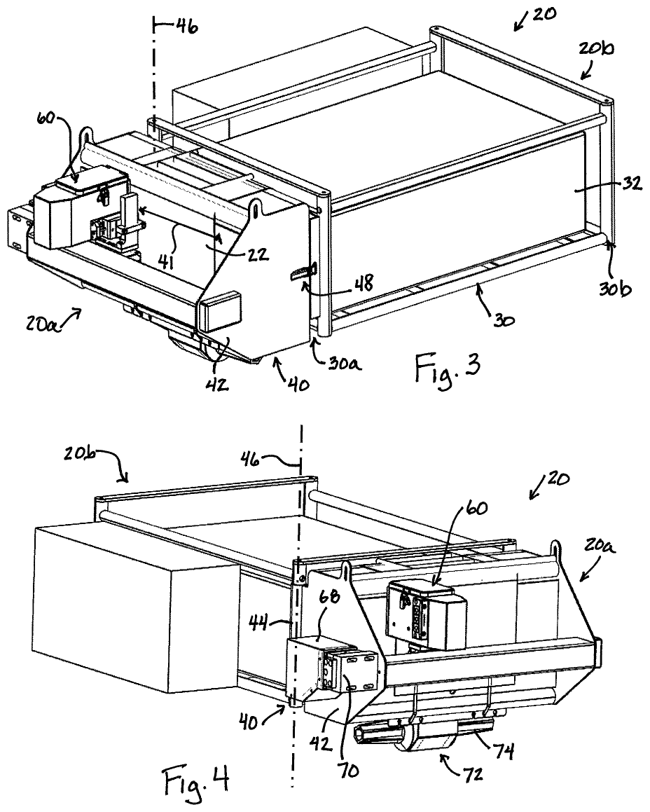

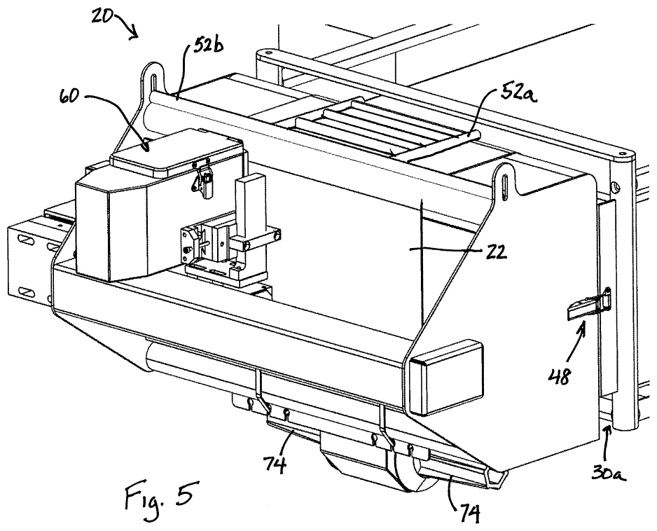

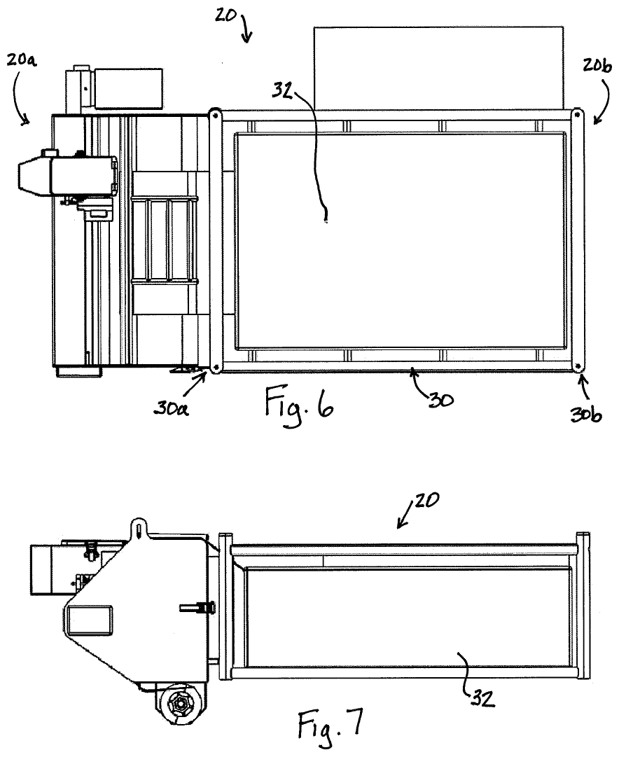

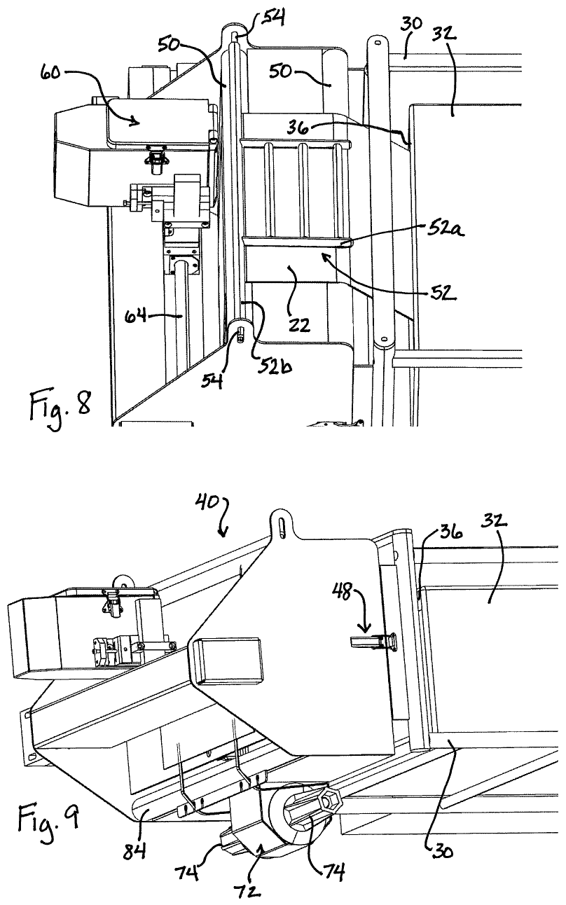

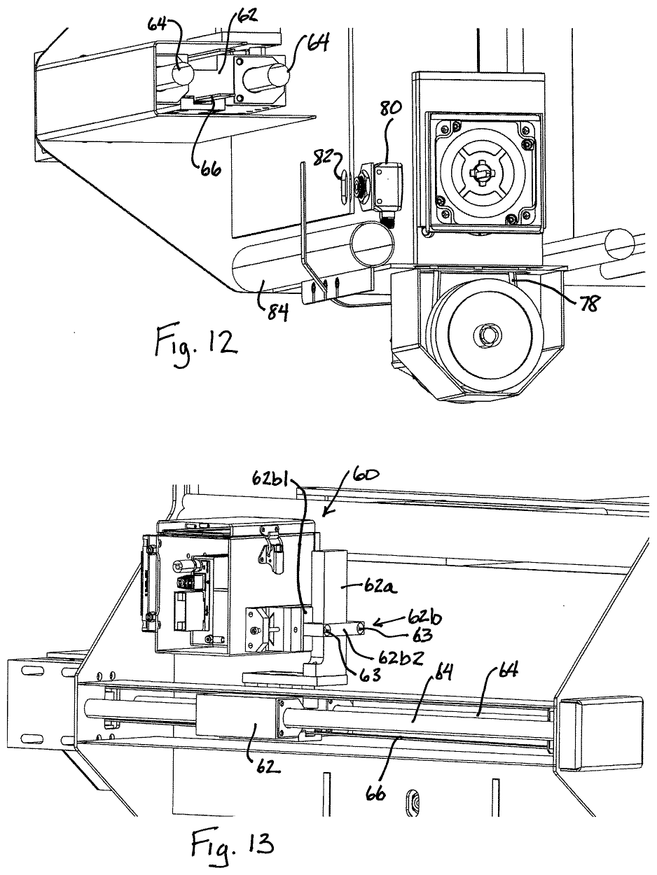

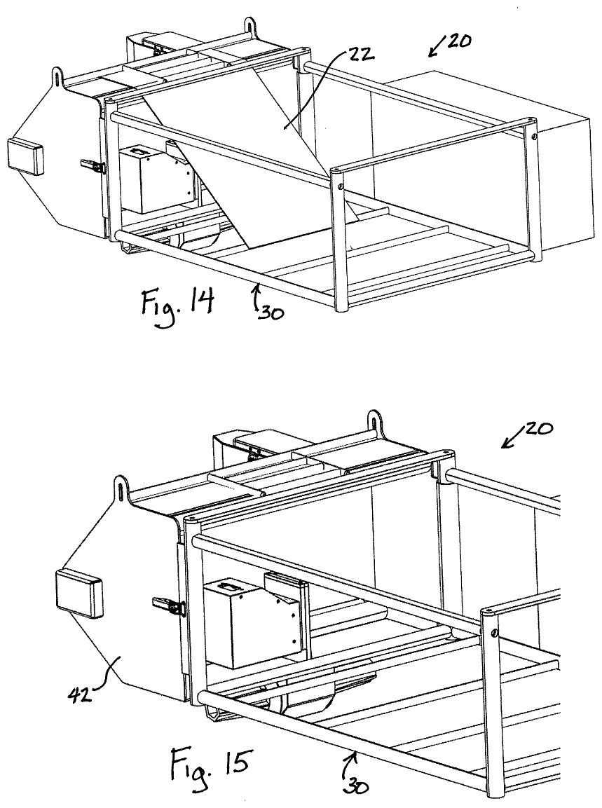

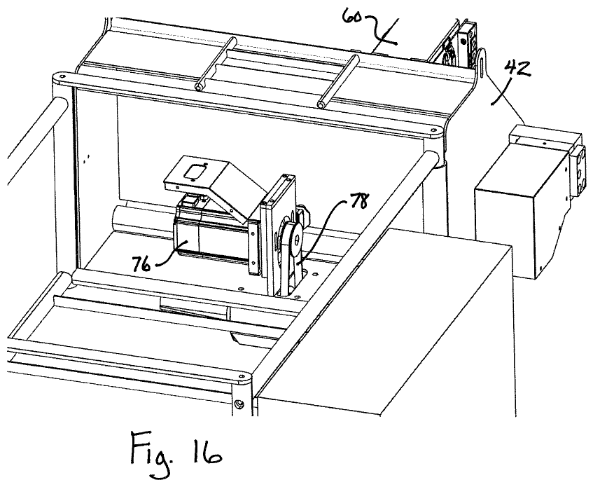

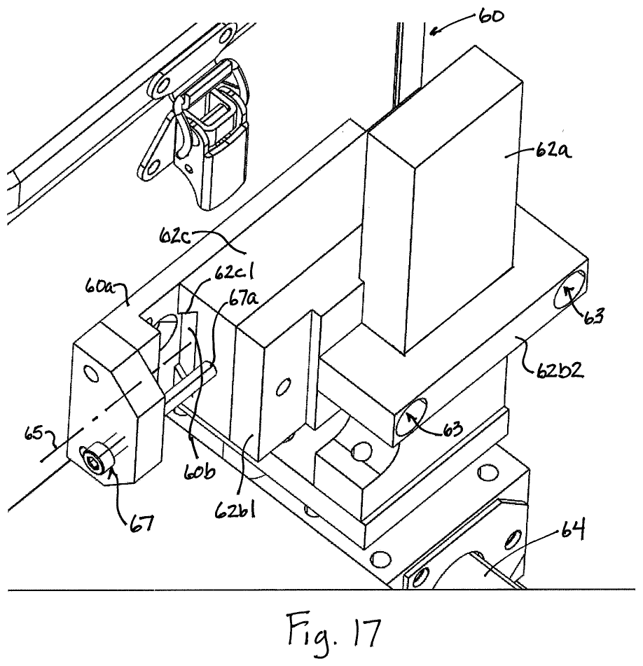

Referring to FIGS. 3-17, details of the bag printer and dispenser 20 are shown. The bag printer and dispenser includes a print and dispense end 20a and an opposite end 20b. A frame structure 30 provides a holding region for the supply of bags, which may typically be contained in a box structure 32 having an end face 34 with a dispense slot 36 that faces toward the print and dispense end 20a. A print and dispense assembly 40 is connected to the frame structure 30 to receive the supply of bags 22 as they are fed out of the box structure 32. The print and dispense assembly 40 includes a mount frame 42 that is mounted on the frame structure 30. Here, one side of the mount frame 42 includes a pivot sleeve 44 mounted for rotation about a corner post of the frame structure 30 to enable the print and dispense assembly to pivot relative to the frame structure about a pivot axis 46. The other side of the mount frame 42 includes a releasable latch assembly 48 (e.g., an over center latch) that is used to hold the print and dispense assembly 40 in the illustrated operating position. When the print and dispense assembly is pivoted away from the frame structure 30, access to internal components of the assembly is provided, and access to the forward end 30a of the frame structure 30 for the purpose of loading/unloading the supply of bags is also provided, which can be useful in installations in which access to rear frame end 30b is prevented or restricted.

A feed path of the bag supply web 22 extends over a top housing part of the print and dispense assembly 40, which includes spaced apart web guide bars or rollers 50. A hold down rack and bar unit 52 includes a rack structure 52a and bar 52b that sit atop the bag supply web 22, where the bar 52b includes opposed ends mounted in opposing slots 54 on the frame 42 so as to enable the rack and bar unit 52 to be lifted upward and/or pivoted for the purpose of initial feed of the bag supply web 22. The bag supply web 22 then runs vertically downward within the mount frame 42 to present the bag surfaces in a substantially planar position and orientation to be printed upon by a thermal inkjet printer 60.

In implementations, the bag supply web 22 is loaded and fed through the machine such that the end portion of each bag that is held to the adhesive strips or tapes 22b is at the leading end of the bag relative to the bag supply web 22 feed direction. A distance along the bag feed path between the hold down rack and bar unit 52 and the final feed location of a printed bag prior to removal is less than a length of each bag in the feed direction, such that, even in its final feed location after printing, each bag is prevented from falling away from the bag supply web due to being engaged by at least part of the hold down rack and bar unit 52 or some other structure.

The printer 60 is mounted so as to be able to move along a web traversing path 41, which traverses across at least part of a width of the bag supply web 22 for the purpose of printing on each bag. Here, the printer 60 is mounted to a movable carriage 62 that rides on a set of parallel guide bars 64. The carriage 62 is clamped to a continuous belt 66 that is driven back and forth by a motor unit (within housing 68) that rotates a drive wheel (in housing 70), with the belt 66 being looped around an idler pulley at the opposite side of the mount frame 42. The printer 60 is mounted to an upwardly extending arm or plate 62a or other mount structure of the carriage 62 via a clamp arrangement 62b that includes a side plate 62b1 on a side of the printer and a clamp bracket 62b2 that extends around the plate 62a. The side plate 62b1 includes a recessed channel 62b1a in which a portion of the plate 62a sits for stabilizing the connection. The clamp bracket 62b2 is fastened to the side plate 62b1 via fasteners 63. When the fasteners 63 are tightened, the position of the side plate 62b1 and clamp bracket 62b1, and thus the printer 60, relative to the arm or plate 62a is fixed. To manually adjust a position of the printer 60, the fasteners 63 are loosened sufficiently to allow the side plate 62b1 and clamp bracket 62b2, along with the printer 60, to be shifted upward or downward along the arm or plate 62a to a new desired position. This arrangement enables a position of printing by the printer along the length of the bag to be modified as desired (e.g., depending upon overall length of the bags, the product being bagged and the product manufacturer's preferred location for bag printing). Other structures for adjustment of the position of the printer 60 relative to the carriage, and thus the printing position of the printer along the length of the bag are possible, such as rack and pinion arrangement or sliding tube arrangement with a set of fixable positions designated by pin holes into which one or more pins may be seated.

The side plate 62b1 is secured (e.g., by fasteners) to a slotted plate 62c, which in turn is slidably connected to the printer by a dovetail or wedge slot 62cl that engages a dovetail or wedge projection 60b of a printer mount plate 60a that is fixed to the printer 60. A position of the printer 60 along an axis 65 of the slot 62cl can be varied by sliding the projection 60b along the slot 62c1. This enables a spacing of a print head of the printer 60 from the bag material to be adjusted as needed for desired print quality. The projection 60b and slot 62cl may have a friction fit for relatively secure and stable positioning of the printer 60. An adjustable set screw/bolt 67 is also provided and has a distal end 67a that is engageable with a side of the slotted plate 62c to further stabilize the position of the printer and define the proper printer position. The printer 60, along with plate 60a, projection 60b and set screw/bolt 67 can also be slid entirely off of the slotted plate 62, in a direction away from the frame structure 30, (e.g., for maintenance etc.) and the sect screw/bolt 67 will define the appropriate position from the printer 60 when reinstalled.

The bag supply web 22 extends downward past the printer 60, such that the adhesive strips 22b extend to a rotatable bag supply drive assembly 72 having a drive reel 74 with spaced apart ends around which adhesive strips 22b extend. Rotation of the reel 74 pulls the adhesive strips 22b and thus advances the entire bag supply web 22, and thus the assembly 72 operates as a bag supply feeder. The ends of the reel 74 are tapered to facilitate removal of the spent adhesive strips 22b after the adhesive strips are cut from the remaining bag supply web 22 (e.g., manually as needed). The reel 74 is selectively driven by a motor unit 76 that moves a continuous belt 78. In this regard, operation of the motor unit 76 is triggered by a bag web sensor system that includes a sensor 80 oriented to detect the presence/absence of bag material through a slot 82. In one implementation, the sensor 80 is an ultrasonic sensor device, but other sensor types may also be used. As seen, the adhesive strips 22b are effectively peeled away from the bag supply web 22 path by movement around a bar 84, and then fed through frame guide slots 86 to reach the real 74. Here, multiple sets of guide slots 86 are provided to facilitate use with different bag supply webs having different spacings between the adhesive strips 22b.

Operationally, when a leading bag of the bag supply web 22 is removed (e.g., manually by a user), the sensor 80 detects that no bag is present in front of the viewing slot 82, and this triggers a feed and print sequence, in which the bag supply drive assembly 72 is controlled to advance the bag supply web 22 further downward until the sensor 80 again detects that a next bag is present in front of the viewing slot, and, after bag advance, the printer 86 is controlled to print required information on the face of the bag 22a that is presented to the printer. Therefore, the distance of advance will correspond to the shingle spacing 24 of the bag supply web. This sequence also assures that the bag presented to the printer for printing is always in a known location, and enables the system to easily be used regardless of the consistency of the shingle spacing of any given bag supply web or differences between shingle spacing of different bag supply webs. However, in embodiments, the printing could occur first, followed by the feeding. The hold down rack and bar unit 52 is configured and weighted such that the forces applied to separate a leading bag from the bag supply web 22 will not cause the bag supply web 22 to advance.

As used herein, the term “leading bag” when referring to the bag supply web means the bag that is first in the direction of feed, such that the bag supply web only has one leading bag at any point in time. After the existing leading bag is separated from the bag supply web, the immediately following bag of the bag supply web becomes the “new leading bag” of the bag supply web, and so on, as bags are separated.

The above description therefore provides for a bag printer and dispenser apparatus that includes a holding structure for a bag supply web formed by a plurality of shingled bags; and a print and dispense mechanism engaged on the holding structure, the print and dispense mechanism including a feed path along which the bag supply web is routed, and a thermal inkjet printer positioned adjacent the feed path and mounted for movement along a web traversing path that runs across at least part of a width of the bag supply web for printing on bags.

In implementations, the print and dispense mechanism includes a bag web feeder for selectively feeding the bag supply web along the feed path, a sensor for detecting a leading end of a leading bag of the bag supply web, wherein the feed path extends downward past the thermal inkjet printer and the sensor is located at an end portion of the feed path below the thermal inkjet printer.

In implementations, the print and dispense mechanism includes a controller associated with bag web feeder and the sensor, wherein the controller is configured to operate the bag web feeder such that detection of the leading end of the leading bag of the bag supply web causes the bag feeder to stop feeding the bag supply web while the web traversing path is still aligned with a face of the leading bag. This means that only a single bag of the bag supply web, particularly the leading bag, ever has print information on it from the inkjet printer at any given time, which closely aligns a timing of the print operation with bag retrieval and use.

In implementations, when the leading end of the leading bag of the bag supply web is in position to be detected by the sensor, the leading end of the leading bag is running in a downward direction and is graspable by a user for separating the leading bag from the bag supply web.

In implementations, the controller is configured such that, upon separation of the leading bag from the bag supply web, the sensor provides an output that causes the controller to carry out a feed and print sequence.

In implementations, the controller is configured such that the feed and print sequence involves first activating the bag web feeder to feed the bag supply web until a leading end of the next leading bag is detected by the sensor and, after feed, operating the thermal inkjet printer to print on a face of a next leading bag of the bag supply web.

In implementations, the print and dispense mechanism includes an upper region over which the feed path extends, the upper region including a hold down structure that sits atop the bag supply web, wherein, when the leading end of the leading bag of the bag supply web is in position to be detected by the sensor, a trailing portion of the leading bag is located in the upper region and the hold down structure is engaged on the trailing portion.

In implementations, the print and dispense mechanism comprises a frame or housing that is pivotably mounted to a frame or housing of the holding structure such that the print and dispense mechanism is pivotably moveable between an operating position adjacent the holding structure and an access position in which one side of the print and dispense mechanism is positioned away from the holding structure.

In implementations, when the print and dispense mechanism is pivoted to the access position, a drive of the bag web feeder is made accessible.

In implementations, a latching mechanism is provided for releasably securing the print and dispense mechanism in the operating position.

The above description also provides for a bag printer and dispenser apparatus that includes a holding structure for a bag supply web formed by a plurality of shingled bags, and a print and dispense mechanism engaged on the holding structure. The print and dispense mechanism includes: a feed path along which the bag supply web is routed; an inkjet printer positioned adjacent the feed path and mounted for movement along a web traversing path that runs across at least part of a width of the bag supply web for printing on bags; a bag web feeder for selectively feeding the bag supply web along the feed path; and a control system configured for detecting a leading end of a leading bag of the bag supply web when the leading bag reaches a retrieval location, the control system configured to control operation of the bag web feeder such that the leading bag is held in the retrieval location until the leading bag is separated from the bag supply web, wherein the web traversing path overlies a portion of a face of the leading bag when the leading bag is in the retrieval location, and a leading section of the bag runs in a downward direction when the leading bag is in the retrieval location.

In implementations, the control system comprises a bag detection sensor and a controller, wherein the bag detection sensor is located along the feed path and below the inkjet printer.

The description also provides for a method of printing and dispensing bags from a bag supply web formed by a plurality of shingled bags, the method involving: selectively feeding the bag supply web along a feed path past a print location; operating a thermal inkjet printer to traverse across at least part of a width of the bag supply web while printing on a face of a leading bag of the bag supply web; holding the leading bag of the bag supply web in a retrieval location in which a leading section of the leading bag extends in a downward direction and the face of the leading bag is still aligned with a traversal path of the thermal inkjet printer.

In implementations of the method, upon separation of the leading bag from the bag supply web, operating the thermal inkjet printer to traverse across at least part of the width of the bag supply web while printing on a face of a new leading bag of the bag supply web and feeding the new leading bag to the retrieval location.

In implementations of the method, the printing on the face of the new leading bag occurs prior to feeding of the new leading bag to the retrieval location.

It is to be clearly understood that the above description is intended by way of illustration and example only and is not intended to be taken by way of limitation. Variations are possible.

1. A bag printer and dispenser apparatus, comprising:
a holding structure for a bag supply web that is formed by a plurality of shingled bags;
a print and dispense mechanism engaged on the holding structure, the print and dispense mechanism including a feed path along which the bag supply web is routed, and a thermal inkjet printer positioned adjacent the feed path and mounted for movement along a web traversing path that runs across at least part of a width of the bag supply web for printing on bags.

2. The apparatus of claim 1, wherein the print and dispense mechanism includes a bag web feeder for selectively feeding the bag supply web along the feed path, a sensor for detecting a leading end of a leading bag of the bag supply web, wherein the feed path extends downward past the thermal inkjet printer and the sensor is located at an end portion of the feed path below the thermal inkjet printer.

3. The apparatus of claim 2, wherein the sensor comprises and ultrasonic sensor device.

4. The apparatus of claim 2, wherein the print and dispense mechanism includes a controller associated with bag web feeder and the sensor, wherein the controller is configured to operate the bag web feeder such that detection of the leading end of the leading bag of the bag supply web causes the bag feeder to stop feeding the bag supply web while the web traversing path is still aligned with a face of the leading bag.

5. The apparatus of claim 4, wherein, when the leading end of the leading bag of the bag supply web is in position to be detected by the sensor, the leading end of the leading bag is running in a downward direction and is graspable by a user for separating the leading bag from the bag supply web.

6. The apparatus of claim 5, wherein the controller is configured such that, upon separation of the leading bag from the bag supply web, the sensor provides an output that causes the controller to carry out a feed and print sequence.

7. The apparatus of claim 6, wherein the controller is configured such that the feed and print sequence involves:
first activating the bag web feeder to feed the bag supply web until a leading end of the next leading bag is detected by the sensor and, after feeding, operating the thermal inkjet printer to print on a face of a next leading bag of the bag supply web;
or
first operating the thermal inkjet printer to print on a face of a next leading bag of the bag supply web and, after printing, activating the bag web feeder to feed the bag supply web until a leading end of the next leading bag is detected by the sensor.

8. The apparatus of claim 4, wherein the print and dispense mechanism includes an upper region over which the feed path extends, the upper region including a hold down structure that sits atop the bag supply web, wherein, when the leading end of the leading bag of the bag supply web is in position to be detected by the sensor, a trailing portion of the leading bag is located in the upper region and the hold down structure is engaged on the trailing portion.

9. The apparatus of claim 1, wherein the print and dispense mechanism comprises a frame or housing that is pivotably mounted to a frame or housing of the holding structure such that the print and dispense mechanism is pivotably moveable between an operating position adjacent the holding structure and an access position in which one side of the print and dispense mechanism is positioned away from the holding structure.

10. The apparatus of claim 9, wherein, when the print and dispense mechanism is pivoted to the access position, a drive of the bag web feeder is made accessible and/or an end of the holding structure is accessible for bag supply web loading and unloading.

11. The apparatus of claim 9, wherein a latching mechanism is provided for releasably securing the print and dispense mechanism in the operating position.

12. The apparatus of claim 1, wherein the printer is mounted to a movable carriage for movement along the web traversing path, wherein a position of the printer on the carriage is manually adjustable for varying a print location of the printer along a length of the bags.

13. The apparatus of claim 12, wherein a releasable clamp arrangement secures the printer to the carriage.

14. A bag printer and dispenser apparatus, comprising:
a holding structure for a bag supply web that is formed by a plurality of shingled bags;
a print and dispense mechanism engaged on the holding structure, the print and dispense mechanism including:
a feed path along which the bag supply web is routed;
an inkjet printer positioned adjacent the feed path and mounted for movement along a web traversing path that runs across at least part of a width of the bag supply web for printing on bags;
a bag web feeder for selectively feeding the bag supply web along the feed path;
a control system configured for detecting a leading end of a leading bag of the bag supply web when the leading bag reaches a retrieval location, the control system configured to control operation of the bag web feeder such that the leading bag is held in the retrieval location until the leading bag is separated from the bag supply web, wherein the web traversing path overlies a portion of a face of the leading bag when the leading bag is in the retrieval location, and a leading section of the bag runs in a downward direction when the leading bag is in the retrieval location.

15. The apparatus of claim 14, wherein the control system comprises a bag detection sensor and a controller, wherein the bag detection sensor is located along the feed path and below the inkjet printer.

16. A method of printing and dispensing bags from a bag supply web formed by a plurality of shingled bags, the method comprising:
selectively feeding the bag supply web along a feed path past a print location;
operating a thermal inkjet printer to traverse across at least part of a width of the bag supply web while printing on a face of a leading bag of the bag supply web;
holding the leading bag of the bag supply web in a retrieval location in which a leading section of the leading bag extends in a downward direction and the face of the leading bag is still aligned with a traversal path of the thermal inkjet printer.

17. The method of 16, further comprising:
upon separation of the leading bag from the bag supply web, operating the thermal inkjet printer to traverse across at least part of the width of the bag supply web while printing on a face of a new leading bag of the bag supply web and feeding the new leading bag to the retrieval location.

18. The method of claim 17, wherein:
the printing on the face of the new leading bag occurs prior to feeding of the new leading bag to the retrieval location;
or
the printing on the face of the new leading bag occurs after feeding of the new leading bag to the retrieval location.
